(19) United States
(12) Patent Application Publication
(10) Pub. No.: US 2016/0039489 A1
(43) Pub. Date: Feb. 11, 2016

(54) Sub-Assembly for a Bike, Trike or Quad

(71) Applicant: Bayerische Motoren Werke Aktiengesellschaft, Muenchen (DE)

(72) Inventor: Christoph PLATZ, Unterschleissheim (DE)

(21) Appl. No.: 14/921,086

(22) Filed: Oct. 23, 2015

Related U.S. Application Data
(63) Continuation of application No. PCT/EP2014/064856, filed on Jul. 10, 2014.

(30) Foreign Application Priority Data
Jul. 25, 2013 (DE) 10 2013 214 588.8

(51) Int. Cl. B62K 11/04; B62K 19/24; B62K 19/10; B62K 19/26; B62K 19/20; B62K 19/08; B62K 19/32; B62K 19/22

(52) U.S. Cl. CPC B62K 11/04; B62K 19/32; B62K 19/24; B62K 19/22; B62K 19/26; B62K 19/20; B62K 19/08; B62K 19/10; B62K 2202/00; B62K 2204/00

(57) ABSTRACT

A sub-assembly for a bike, trike or quad, more particularly for a motorcycle or a motor scooter, includes a steering head and at least one profile element connecting the steering head to a supporting part of the bike, trike or quad, more particularly to a main frame, engine housing or battery casing or a part thereof. The profile element in the sub-assembly is made from a shaped piece of sheet metal.

### CROSS REFERENCE TO RELATED APPLICATIONS

This application is a continuation of PCT International Application No. PCT/EP2014/064856, filed Jul. 10, 2014, which claims priority under 35 U.S.C. §119 from German Patent Application No. 10 2013 214 588.8, filed Jul. 25, 2013, the entire disclosures of which are herein expressly incorporated by reference.

### BACKGROUND AND SUMMARY OF THE INVENTION

The invention relates to a sub-assembly for a bike, trike or quad, more particularly for a motorcycle or a motor scooter, including a steering head and at least one profile part. The at least one profile part connects the steering head to a supporting part of the bike, trike or quad, more particularly to a main frame, engine housing or battery casing or a part thereof.

In the case of the vehicles mentioned, the fork or the steering tube is guided and rotatably mounted in the steering head (also referred to as the steering crown). The steering head is a highly stressed part of the underbody that must be stably and precisely worked, not least because it is a safety component.

The steering head is usually produced from a steel tube, but it may also be assembled or cast from turned parts. The fastening of the steering head usually takes place with welded-on profiles of steel or aluminum, which together form the frame of the vehicle, or in a common cast component.

A disadvantage of such sub-assemblies is the poor relationship between weight and structural stiffness, i.e. a sufficient structural stiffness can only be achieved with a relatively heavy sub-assembly. The object of the invention is to improve a sub-assembly of the type mentioned at the beginning in this respect.

This and other objects are achieved by a sub-assembly according to the invention for a bike, trike or quad, more particularly for a motorcycle or a motor scooter. The sub-assembly includes a steering head and at least one profile part, which connects the steering head to a supporting part of the bike, trike or quad, more particularly to a main frame, engine housing or battery casing or a part thereof. The profile part of the sub-assembly is formed from a shaped piece of sheet metal.

The invention is based on the realization that weight can be saved by using a sheet-metal part. A pre-requisite for using a sheet-metal part—instead of previously conventional steel tubes—is a comparable structural stiffness. This can be achieved by a relatively great cross-sectional profile.

Conversely, a greater stiffness than with a steel tube can be achieved with the same weight by the lightweight structural design according to the invention.

A further major advantage of the invention can be seen in the fact that sheet metal can be processed more easily than tubes or cast components, so that the production technology according to the invention also leads to a cost saving.

In the case of the preferred embodiment of the sub-assembly, it is provided that the profile part is bent from a cut sheet-metal plate. In this case it is possible to dispense with elaborate deep drawing.

The steering head on the other hand is preferably a cast part.

The steering head can best be fastened to the profile part by means of a welded connection. However, an adhesively bonded connection or a screwed connection between the profile part and the steering head is also possible, in principle.

Similarly, a welded connection, an adhesively bonded connection or a screwed connection may be provided between the profile part and the supporting part of the vehicle.

Aluminum is particularly suitable as the material for the profile part, since an aluminum sheet can be processed well and the material has been used successfully in vehicle construction.

The steering head may also consist substantially of aluminum, and so too the supporting part on which the profile part is fastened to the steering head.

According to a preferred embodiment of the invention, two, preferably symmetrical, profile parts are placed against one another on the steering head and together form a frame portion. Two profile parts that are placed against one another during assembly are generally easier to handle than a corresponding one-piece profile part.

According to a preferred application of the invention, the profile part at the same time forms the side wall of a battery casing. This means that the profile part is formed in one piece with the side wall. Ideally, the profile part and the side wall are formed from the same piece of sheet metal.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a first perspective view of a sub-assembly according to an embodiment of the invention;

FIG. 2 is a second perspective view of the sub-assembly from FIG. 1; and

FIG. 3 is a perspective view of a bike with the sub-assembly from FIG. 1.

### DETAILED DESCRIPTION OF THE DRAWINGS

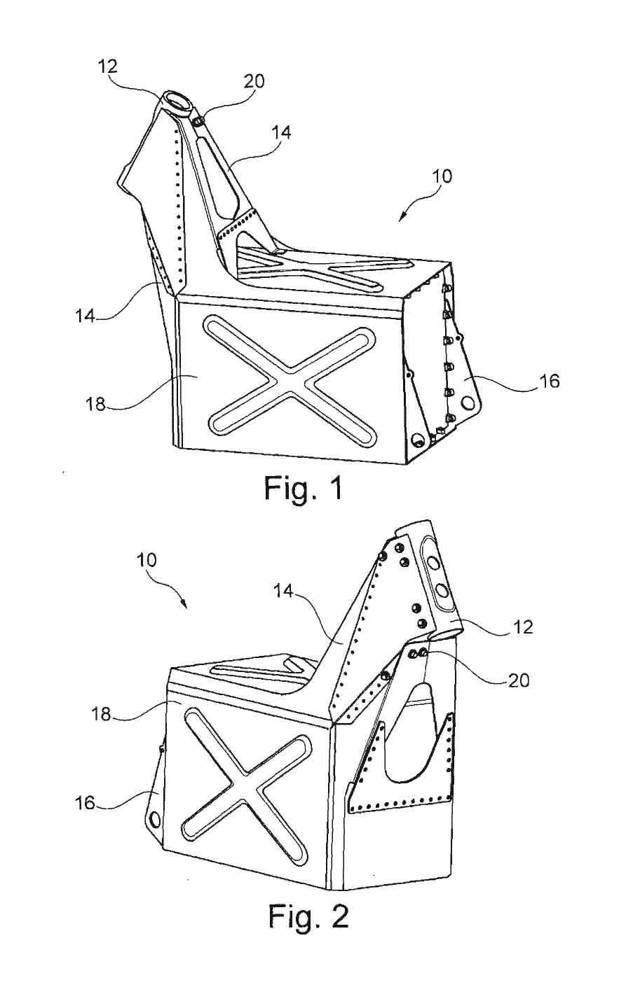

In FIGS. 1 and 2, a sub-assembly 10 for a bike, trike or quad, more particularly for a motorcycle or motor scooter, is shown. The sub-assembly 10 consists substantially of a steering head 12, two profile parts 14 and a supporting part 16. The supporting part 16 may, more particularly, be a main frame, an engine housing or, as here, part of a battery casing of the vehicle. As a departure from what the figures show, instead of two profile parts 14 that are placed against one another on the steering head 12 and together form a frame portion, it is also possible for only a single (one-piece) profile part to be provided. The single profile is formed in a way corresponding to the two profile parts 14 that are placed against one another.

The profile parts 14 connect the steering head 12 to the supporting part 16. In the exemplary embodiment represented, two symmetrical profile parts 14 are provided, at the same time respectively forming a side wall 18 of the battery casing, i.e. the profile parts 14 are formed as one piece with the side walls 18. The supporting part 16 has a C-shaped cross section here, so that, together with the side walls 18, the supporting part 16 forms a battery casing that is open on one side.

In a manner similar to the hollow steering head 12 and the supporting part 16, the profile parts 14 consist substantially of aluminum. The steering head 12 is a cast part; the profile parts 14, on the other, hand are formed from a shaped piece of sheet metal. To be more precise, each profile part 14 is bent from a cut sheet-metal plate. In another embodiment, the profile parts 14 are formed from a deep-drawn piece of sheet metal. The same applies correspondingly here to the supporting part 16.

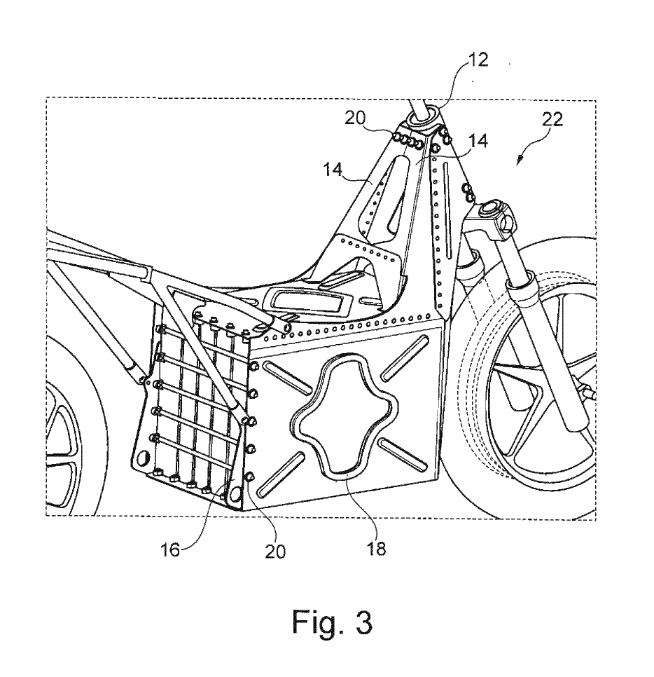

In FIGS. 1 and 2, on one of the two profile parts 14 (at the rear in FIG. 1 and at the front in FIG. 2), screws 20 of a screwed connection between the profile part 14 and the steering head 12 can be seen. FIG. 3, which shows the sub-assembly 10 when used in the example of a motorcycle 22, reveals that the profile parts 14, to be more precise the side walls 18, are also screwed to the supporting part 16. It goes without saying that riveted connections may also be provided instead of the screwed connections. Similarly, it is possible in principle to connect the profile parts 14 to the steering head 12 and/or to the supporting part 16 by welding or adhesive bonding.

In comparison with conventional connecting parts, together the profile parts 14 have or produce a very large cross section, which provides the necessary stability. The profile parts 14, respectively formed from a piece of sheet metal, consequently have the same structural stiffness as a very much heavier connecting part of steel. Nevertheless, further reinforcing sheets may be additionally provided to increase the stability further.

The wall thickness of the aluminum sheet used for the profile parts 14 is approximately 1 to 2.5 mm. In comparison with a conventional front frame of steel tubes, a considerable weight saving is obtained with the same or even better stiffness.

List of Designations

10 sub-assembly

12 steering head

14 profile part

16 supporting part

18 side wall

20 screws

22 motorcycle

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A sub-assembly for a bike, trike, or quad, the sub-assembly comprising:
a steering head;
a supporting part of the bike, trike, or quad; and
at least one profile part connecting the steering head to the supporting part, wherein the at least one profile part is a shaped piece of sheet metal.

2. The sub-assembly according to claim 1, wherein the supporting part is a main frame, an engine housing, or at least part of a battery casing of the bike, trike, or quad.

3. The sub-assembly according to claim 1, wherein the profile part is bent from a cut sheet-metal plate.

4. The sub-assembly according to claim 1, wherein the steering head is a cast part.

5. The sub-assembly according to claim 3, wherein the steering head is a cast part.

6. The sub-assembly according to claim 1, further comprising a screwed connection, a riveted connection, a welded connection, or an adhesively bonded connection between the profile part and the steering head.

7. The sub-assembly according to claim 5, further comprising a screwed connection, a riveted connection, a welded connection, or an adhesively bonded connection between the profile part and the steering head.

8. The sub-assembly according to claim 1, further comprising a screwed connection, a riveted connection, a welded connection, or an adhesively bonded connection between the profile part and the supporting part.

9. The sub-assembly according to claim 6, further comprising a screwed connection, a riveted connection, a welded connection, or an adhesively bonded connection between the profile part and the supporting part.

10. The sub-assembly according to claim 7, further comprising a screwed connection, a riveted connection, a welded connection, or an adhesively bonded connection between the profile part and the supporting part.

11. The sub-assembly according to claim 1, wherein the profile part is substantially formed of aluminum.

12. The sub-assembly according to claim 11, wherein the steering head is substantially formed of aluminum.

13. The sub-assembly according to claim 1, wherein the steering head is substantially formed of aluminum.

14. The sub-assembly according to claim 1, wherein the supporting part is substantially formed of aluminum.

15. The sub-assembly according to claim 12, wherein the supporting part is substantially formed of aluminum.

16. The sub-assembly according to claim 1, further comprising two profile parts, said two profile parts being arranged against one another on the steering head in order to form a portion of a main frame of the bike, trike, or quad.

17. The sub-assembly according to claim 16, wherein the two profile parts are symmetrical.

18. The sub-assembly according to claim 1, wherein the profile part is configured to form a side wall of a battery casing.

19. The sub-assembly according to claim 2, wherein the profile part is configured to form a side wall of the battery casing.

20. The sub-assembly according to claim 1, wherein the sub-assembly is a motorcycle or motor scooter sub-assembly.
